(19) United States
(12) Patent Application Publication
(10) Pub. No.: US 2024/0311547 A1
(43) Pub. Date: Sep. 19, 2024

(54) USER INTERFACE FOR INDUSTRIAL PLANT MANAGEMENT

(71) Applicant: Jensen Hughes, Inc., Baltimore, MD (US)

(72) Inventors: Andrew P. Miller, West Chester, PA (US); Jonathan L. Hodges, Blacksburg, VA (US); Stephen M. Hess, West Chester, PA (US)

(21) Appl. No.: 18/608,286

(22) Filed: Mar. 18, 2024

Related U.S. Application Data
(60) Provisional application No. 63/453,294, filed on Mar. 20, 2023.
(60) Provisional application No. 63/452,954, filed on Mar. 17, 2023.

(51) Int. Cl. G06F 40/109; G05B 23/02; G06F 40/205; G06F 40/289

(52) U.S. Cl. CPC G06F 40/109; G06F 40/205; G06F 40/289; G05B 23/0272

(57) ABSTRACT

A method for interpreting incident reports parses an incident report. The method determines abnormal condition scores, each abnormal condition score corresponding to at least one parsed word of the incident report. The method determines normal condition scores, each normal condition score corresponding to at least one parsed word of the incident report. The method generates a user interface having a visual representation of the incident report. The method marks a set of parsed words corresponding to a portion of the abnormal condition scores using a first visual indicator. The method marks another set of parsed words corresponding to a portion of normal condition scores using a second visual indicator.

### PRIORITY

This patent application claims priority from provisional U.S. patent application No. 63/452,954, filed Mar. 17, 2023, and entitled, “USER INTERFACE FOR INDUSTRIAL PLANT MANAGEMENT,” and naming Andrew P. Miller et al. as inventors; and U.S. patent application No. 63/453,294, filed Mar. 20, 2023, and entitled, “MACHINE LEARNING-BASED INCIDENT REPORT CLASSIFICATION,” and naming Jonathan L. Hodges et al., the disclosures of which are incorporated herein, in its entirety, by reference.

### FIELD

Illustrative embodiments of the invention generally relate to industrial monitoring and, more particularly, various embodiments of the invention relate to a user interface for incident report management.

### BACKGROUND

Incident reports may be used to maintain, among other things, industrial facilities by indicating whether a facility is experiencing normal or abnormal conditions. As the number of incident reports increases, operators may be overwhelmed by the volume of incident reports to review, not having sufficient time to review all incident reports and identify potentially hazardous abnormal conditions at the facility.

### SUMMARY OF VARIOUS EMBODIMENTS

A method for interpreting incident reports parses an incident report. The method determines abnormal condition scores, each abnormal condition score corresponding to at least one parsed word of the incident report. The method determines normal condition scores, each normal condition score corresponding to at least one parsed word of the incident report. The method generates a user interface having a visual representation of the incident report. The method marks a set of parsed words corresponding to a portion of the abnormal condition scores using a first visual indicator. The method marks another set of parsed words corresponding to a portion of normal condition scores using a second visual indicator.

In some embodiments, parsing the incident report includes dividing the incident report into at least two portions; dividing the first portion of the incident report into individual words; and determining phrases in the second portion of the incident report. The at least one parsed word corresponding to one of the abnormal condition scores is one of the individual words of the first portion or one of the phrases of the second portion.

Determining the phrases may include determining two-word phrases or three-word phrases.

In some embodiments, the method ranks the abnormal condition scores; determines the portion of the abnormal condition scores after ranking the abnormal condition scores; ranks the normal condition scores; and determines the portion of normal condition scores after ranking the abnormal condition scores.

Determining the portion of the normal condition scores includes comparing a first normal condition score and a first abnormal condition score corresponding to the same parsed word.

In some embodiments, the method marks the set of parsed words corresponding to the portion of the abnormal condition scores using a third visual indicator based on the ranking of the abnormal conditions scores; and marks the set of parsed words corresponding to the portion of the normal condition scores using a fourth visual indicator based on the ranking of the normal condition scores.

The first visual indicator may include highlighting in a first color, the second visual indicator may include highlighting in a second color, and the third and fourth visual indicators may include degrees of highlighter tinting.

Parsing the incident report may include stemming a word of the incident report. Marking the set of parsed words corresponding to the portion of the abnormal condition scores includes determining positions of the parsed words within the incident report.

In some embodiments, the method flags the incident report in response to the abnormal condition scores and the normal condition scores.

Each of the plurality of abnormal condition scores may indicate a likelihood of an abnormal condition given the inclusion of the corresponding at least one parsed word in a given portion of the incident report.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a flag list user interface in accordance with various embodiments.

FIG. 2 schematically shows an incident report user interface in accordance with various embodiments.

FIG. 3 schematically shows an incident report text section of the incident report user interface in accordance with various embodiments.

FIG. 4 schematically shows a ranking section of the incident report user interface in accordance with various embodiments.

FIG. 5 schematically shows a flag section of the incident report user interface in accordance with various embodiments.

FIG. 6 shows a process for interpreting incident reports in accordance with various embodiments.

FIG. 7 schematically shows a computing device in accordance with various embodiments.

### DESCRIPTION OF ILLUSTRATIVE EMBODIMENTS

In illustrative embodiments, a user interface displays an incident report (IR) that has been flagged for review by a user. An incident report may be defined as a written account of a worksite event or condition, among other things. An incident report may detail an event causing or nearly causing damage to person or property at a worksite, such as an industrial facility, among other things. The user interface displays text of the incident report, marking the important text of the incident report is key to deciding whether the incident report requires further action to address, such as forwarding the incident report for further review or scheduling maintenance or repair. The marking may indicate a subset of the most significant words, as well as a ranking of the most important marked words, thereby assisting the user with reviewing the incident report. Details of illustrative embodiments are discussed below.

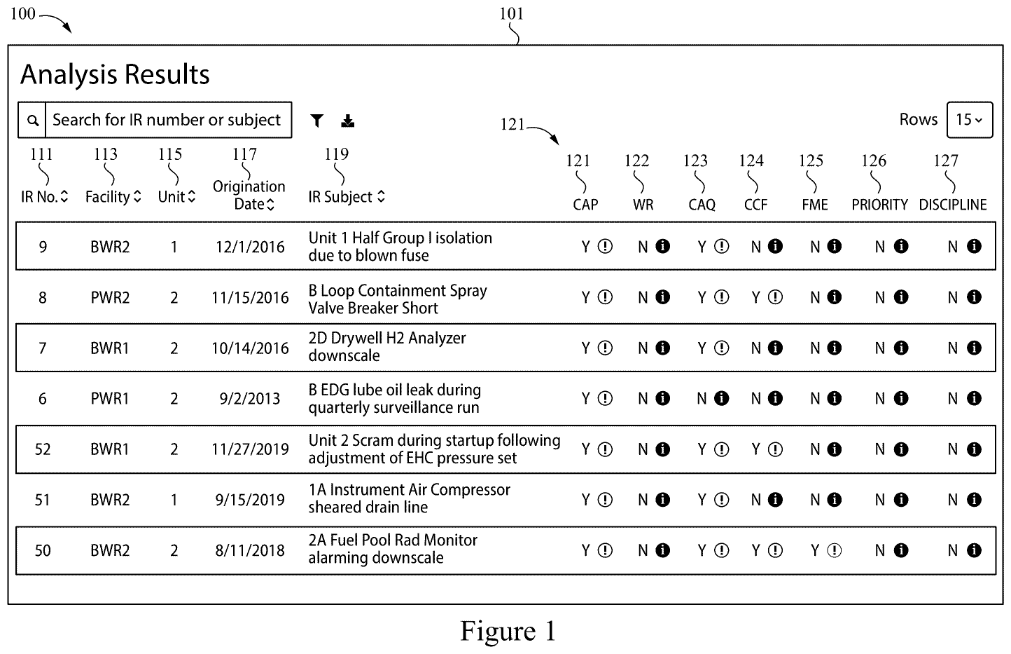

FIG. 1 schematically shows a flag list user interface 100 displayed on a screen 101 configured to identify incident reports flagged for user review. Each row represents one incident report and includes information such as an incident identifier 111 for distinguishing among incident reports, a facility identifier 113 for identifying the location to which the incident report corresponds, a unit identifier 115 for identifying the unit to which the incident report corresponds, an origination date identifier 117 for identifying the date of the event described in the incident report, and the subject text portion 119 of the incident report.

Each row also has flag indicators 120 indicating under which metric the incident report has been flagged. In the illustrated embodiment, a metric indicating the incident report has been flagged is represented by a “Y” for yes and a selectable icon including an exclamation mark. A metric indicating the incident report should not be flagged is represented by an “N” for no and a selectable icon including an “i” for information. Other embodiments may indicate flagging/not flagging using other indicators. It should be appreciated the flag list user interface 100 may display more, fewer, or different metrics for evaluating the incident report. In the illustrated embodiment, the flag indicators 120 correspond to metrics 121-127.

The corrective action program (CAP) metric 121 may be flagged if the incident report indicates the incident report should be submitted to a corrective action program. In some embodiments, the corrective action program ensures all conditions adverse to quality are promptly notified and corrected. The corrective action program may be a program established pursuant to 10 C.F.R. 72.172, among other things. 10 C.F.R. 72.172 requires that all significant conditions identified as adverse to quality must have a root cause analysis, measures taken to preclude repetition, and the corrective action documented and reported to management. The condition against quality (CAQ) metric 123 may be flagged if the incident report documents a significant condition adverse to quality.

Some incident reports must be resolved by performing work on an asset of the facility. A work order may authorize the work to be performed. In order to obtain a work order, a work request may be submitted. The work request metric 122 may be flagged if the incident report indicates a work request must be submitted to resolve the incident report.

Work requests may be addressed according to one of several timelines, such as a standard maintenance timeline or a high priority timeline. Most work requests may be addressed under the standard timeline. However, certain high priority requests must be addressed more quickly. The work request-priority metric 126 may be flagged if the incident report indicates the work request should be addressed according to a high priority timeline.

Work requests may be routed to one of several possible maintenance groups. The work request-discipline metric 127 may be flagged if the incident report indicates a work request should be addressed by a certain discipline team, such as a fix-it-now team rather than a standard maintenance team, among other things

The worksite may have a number of critical components. A critical component may be defined by INPO AP-913. For example, the critical component may be a component which, when damaged, causes any of the following conditions: reactor scram or trip, power transient of greater than 20% plant transient, failure of a MSPI monitored component, a complete loss of a critical safety function, or an equipment failure which results in a maintenance rule high safety significance or risk significant function. The critical components failure (CCF) 124 may be flagged if the incident report indicates a critical component has failed, or may fail over a forecasted time period.

When a material which is not a part of the system design enters the system, the event may be referred to as a foreign material intrusion or foreign material event (FME). The FME metric 125 may be flagged if the incident report indicates a foreign material event has occurred.

A flagged metric may indicate a user should review the incident report for the presence of the indicated condition or event. The illustrated metrics are some examples of metric for which an incident report may be evaluated and flagged.

Other embodiments may include alternative metrics. For example, the flag indicators 120 may include a maintenance rule functional failure metric, which may be flagged if the incident report indicates maintenance rule functional failure has occurred. A maintenance rule functional failure may include a failure which results in the loss of a safety function. The loss of a safety function may be defined by 10 C.F.R. 50.65, among other things.

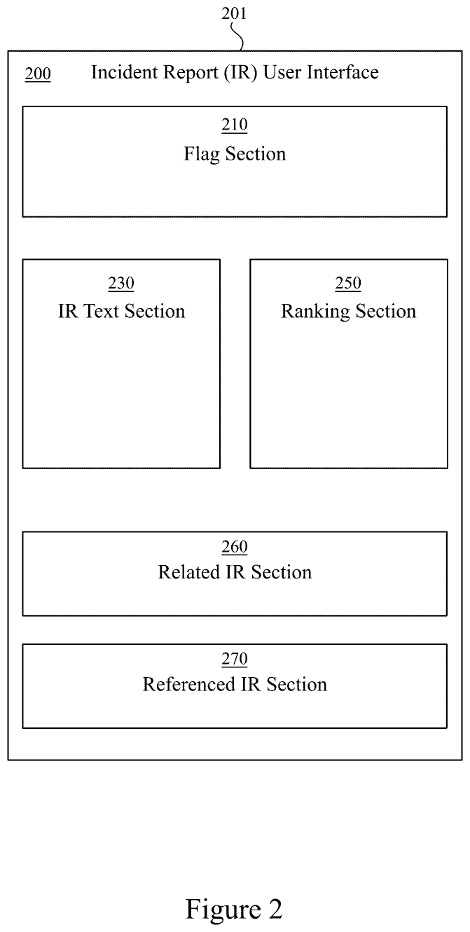

FIG. 2 schematically shows an IR user interface 200 displayed on a screen 201 having multiple sections to display information related to one of the incident reports selected on the flag list UI 100. The incident report user interface 200 may convey information regarding the analysis of one of the metrics indicated on the flag list UI 100. The interface may include a controllable element, such as a drop-down list, among other things, to navigate from the displayed metric analysis to the analysis of another metric for the same incident report.

The IR user interface 200 has an IR text section 230 to display the text of the incident report. In some embodiments, the text of the incident report is divided by headings, and the IR text section 230 correspondingly divides the text of the incident report by the headings. In some embodiments, the IR text section 230 has a template of headings, some of which may not be used by some of the incident reports listed in the flag list UI 100, such that some of the template headings are displayed but have no corresponding text to display in IR text section 230. The text of the incident report displayed in IR text section 230 may be collapsible by headings.

In addition to the text of the incident report, the IR text section 230 also has markings to emphasize certain words. A “word” may be a set of grouped letters (e.g., “user”), a set of grouped numbers (e.g., “61850”), a set of grouped letters and numbers (“DNP3”), or a set of grouped characters (e.g., “user-assisted”) separated from other words by punctuation such as a dash or hyphen, among other things. It should be appreciated that the term “word” or “words” may be understood to include a single word or multiple words grouped together, referred to herein as a phrase. The marked words or phrases, based on associated abnormal or normal condition scores, may be the most significant words in the incident report for indicating whether an incident report should be flagged or not flagged.

The markings, also known as visual indicators, may be any kind of mark to indicate text, such as underlining, emboldening, italicizing, highlighting, font size changes, or case changes, among other things. For example, words or phrases indicating a report that should be flagged for review may be highlighted in one color, while other words indicating a report that should not be flagged for review may be highlighted in another color. In addition to the marking indicating flagged/not flagged, the markings may also indicate a degree to which the marked word indicates a report should be flagged/not flagged. For example, the words highlighted in one color may have tinted highlighting to representing which of the highlighting words were more significant.

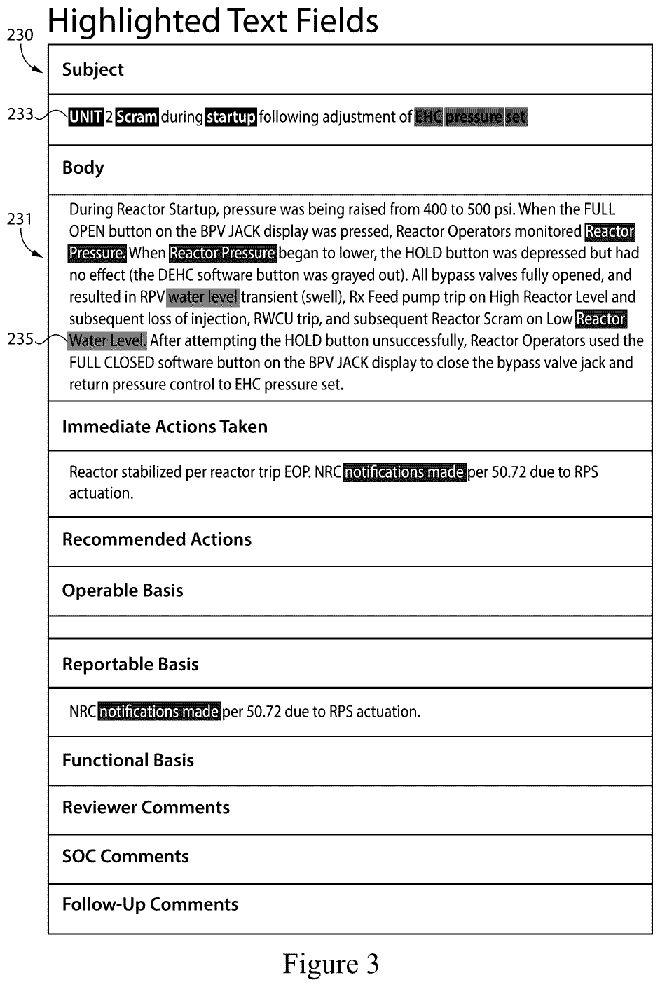

FIG. 3 schematically shows an example of the IR text section 230 in accordance with various embodiments. In the illustrated IR text section 230, the text of the incident report is split into portions 231 by headings. In other embodiments, the incident report may be divided differently. In the illustrated embodiment, the headings were derived from an incident report template. Since the incident report only includes text for the subject, body, immediate actions taken, and reportable basis headings, the remaining headings of the template headings do not include text.

The IR text section 230 includes words marked with abnormal condition visual indicators 233 and other words marked with normal condition visual indicators 235. There are visual indicators to distinguish between words associated with abnormal conditions and words associated with normal conditions. For example, the words marked by the abnormal condition visual indicators 233 are marked with black highlighting, while the words marked by the normal condition visual indicators 235 are marked with gray highlighting. In other embodiments, the visual indicators used to distinguish between abnormal condition words and normal condition words may include colored highlighting, such as orange to indicate abnormal condition words and blue to indicate normal conditions words, among other things. Both the abnormal condition visual indicators 233 and the normal condition visual indicators 235 include a visual indicator representing a range of values, which may correspond to a ranked score assigned to each word. For example, the abnormal condition visual indicators 233 include emboldened words corresponding to high-tier ranked words, and non-emboldened words corresponding to a low-tier ranked words. In other embodiments, the visual indicator range corresponding to ranked scores may be indicated by the tinting of highlighting, among other things. For example, a high score may be indicated by a darker tinting of the highlighting, and a lower score may be indicated by a light tinting of the highlighting among other things. In this way, the visual indicators corresponding to each word may indicate whether the word is associated with a normal condition or abnormal condition, as well as the ranking of the scoring within the normal condition/abnormal condition categories.

It is important to note that different sections of the incident report may be parsed differently, and thus a word marked in one text portion may not be marked in another text section, as shown by the visual indicators in FIG. 3. The subject portion of the incident report is parsed by individual words, while the other portions of the incident report are at least in part parsed by sets of words, also referred to herein as phrases.

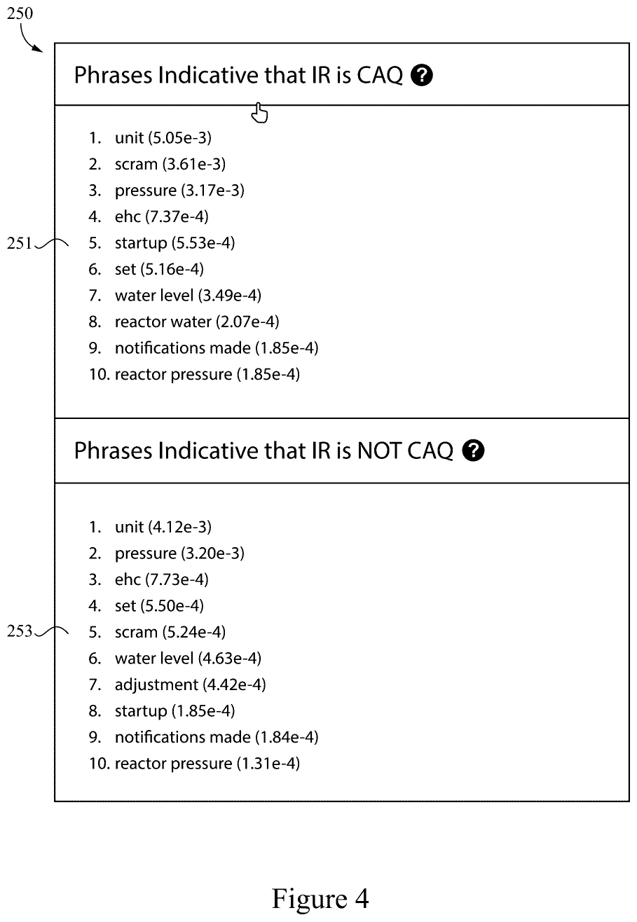

The IR user interface 200 includes a ranking section 250 displaying a portion of the words of the incident report and corresponding scores. The ranking section displays the most significant words or phrases, according to their corresponding abnormal/normal condition scores. One example of the ranking section 250 is illustrated in FIG. 4, where the ranking section 250 has an abnormal condition ranked word list 251 and a normal condition ranked word list 253. Each list may include individual words, phrases, or a combination thereof, as illustrated in FIG. 4.

In the illustrated embodiment, each list has ten words or phrases, but other embodiments may include lists having a different number of words or phrases, or lists having an unequal number of words and phrases. For each word or phrase in both lists, there is a corresponding displayed score. The abnormal condition ranked word list 251 includes abnormal condition score for each word or phrase and normal condition ranked word list 253 includes the normal condition score for each word or phrase.

The word lists 251, 253 may identify the words to be marked in the IR text section 230. As in the illustrated case, some words or phrases may be included in both lists 251, 253 because the word or phrase has high abnormal condition scores and normal condition scores. For example, the term “unit” is the most significant term for both the abnormal condition ranked list 251 and the normal condition ranked list 253. Where a word or phrase is significant to both flagging and not flagging a report, the word or phrase may be marked based on the higher of the normal condition score and the abnormal condition score for the word or phrase, among other things. For example, since the abnormal condition score is higher for “unit” compared to the normal condition score, the IR text 230 marks “unit” with an abnormal condition visual indicator 233.

It is also important to note the IR text section 230 marks texts according to how the portions 231 were parsed. For example, the word “startup” appears in both lists 251, 253, with the abnormal condition score for “startup” being higher than the normal condition score. However, “startup” is only marked in the subject portion of the incident report, because only the subject portion was parsed for individual words. The remaining sections were parsed by dividing the portions into multi-word phrasing. Thus, “Reactor Startup” in the body section is not marked.

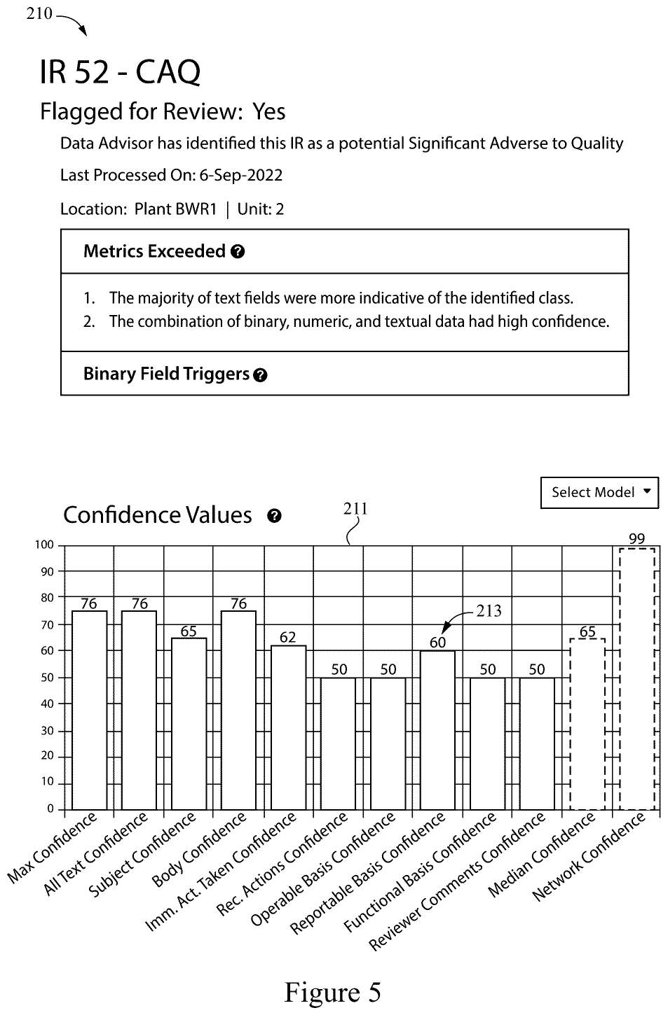

The IR user interface 200 has a flag section 210 for displaying analysis as to whether the incident report was flagged for review or not flagged for review. FIG. 5 shows the flag section 210 according to various embodiments. The flag section 210 indicates the incident report identifier 111 and the specific metric to which the analysis corresponds. As shown in FIG. 5, the flag section 210 indicates the incident report was flagged for review according to the CAQ metric 123. The flag section 210 also includes the location identifier 113, and the unit identifier 115.

The flag section 210 includes a graph 211 showing confidence values 213 corresponding the outcome of different analyses related to the incident report. Each confidence value indicates the likelihood the incident report should be flagged based on an analysis of one or more of the text portions 231, among other things. In the illustrated embodiment, each individual text portion of the incident report, divided by the template headings, has a confidence value 213. The additional confidence values 213 include a confidence value equal to the maximum text portion confidence value (“Max Confidence”), a confidence value equal to the median of the text portion confidence values (“Median Confidence”), a confidence value corresponding to the entire text of the incident report (“All Text Confidence”), and a network confidence score (“Network Confidence”) based on a neural network analysis using, as inputs, the other confidence values, as well as other data concerning the incident report.

Each of the confidence values may be compared to respective thresholds to determine if the confidence value indicates the incident report should be flagged for review. The thresholds may be set automatically or set by a user to balance the occurrence of false flagging positives and false flagging negatives. A confidence value that exceeds its respective threshold is an abnormal condition, and will cause the incident report to be flagged for review according to the particular metric. As shown in FIG. 5, the median confidence value and the network confidence value have exceeded their thresholds and are marked with a dashed line, indicating an abnormal condition. The remaining confidence values are below their threshold and are thus marked differently (solid lines) to indicate normal conditions. Because one of the metrics indicates an abnormal condition, the incident report is flagged for review under the CAQ metric 123.

The IR user interface 200 has a related IR section 260 visually representing other incident reports with at least one attribute common to the IR addressed in sections 210, 230, and 250 of the IR. The common attribute may be a common facility, unit, confidence values, equipment, included words/phrases, marked words/phrases, abnormal condition scores, or normal condition scores, among other things.

The IR user interface 200 has a referenced IR section 270 showing the other incident reports referenced in the incident report displayed in the IR text section 230. Among other things, the referenced IR section 270 may provide a link to the referenced incident report(s).

It should be appreciated that the arrangement of the IR user interface 200 may appear differently in other embodiments. For example, the IR user interface 200 may have only the IR text section 230 and at least one of the ranking section 250 and the flag section, among other things.

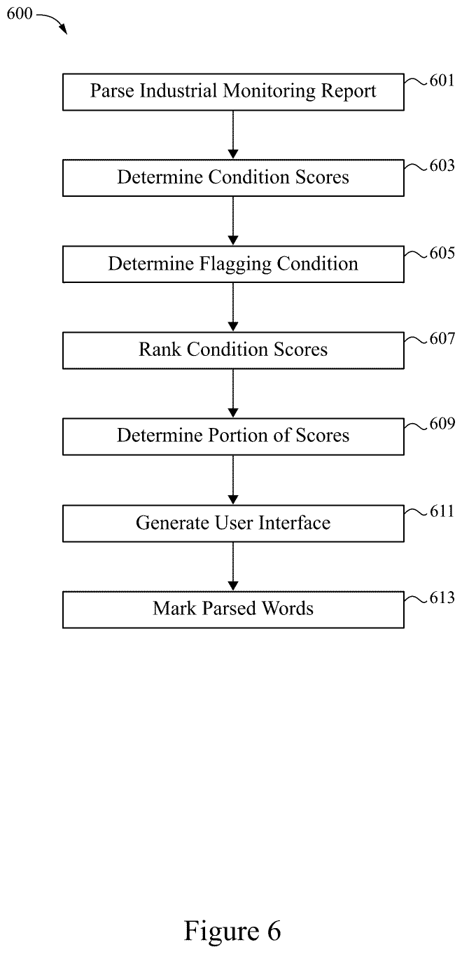

FIG. 6 shows an exemplary process 600 for interpreting an incident report through visualization using the IR user interface 200, in accordance with various embodiments. Process 600 may be implemented in whole or in part in one or more of the computing devices disclosed herein. In certain forms the functionalities may be performed by separate computing devices. In certain forms, all functionalities may be performed by the same device. It shall be further appreciated that a number of variations and modifications to the process 600 are contemplated including, for example, the omission of one or more aspects of process 600, the addition of further conditionals and operations, or the reorganization or separation of operations and conditionals into separate processes.

The process 600 begins at operation 601 by parsing an incident report. Parsing the incident report may include dividing the text of the incident report into text portions. Among other things, the text portions may be defined by report headings, as shown in the IR text section 230 illustrated in FIG. 3.

Parsing the incident report may also include dividing the text of the incident report, or the text portions 231 thereof, into individual words or multiple word phrases. For example, the text may be divided into unigrams, bigrams, or trigrams, among other things. In some embodiments, the text of the incident report is first divided into text portions by headings, then divided into individual words or phrases within each text portion. In some embodiments, some text portions may be divided into phrases while other text portions are divided into individual words. For example, text portions, such as the text section under the subject heading may be divided into individual words, while the other text portions are divided into phrases, or a combination or words and phrases.

In some embodiments, dividing a text section into phrases includes determining a plurality of phrases where multiple phrases may include the same word of the text section. For example, “increasing reactor pressure” may be used to determine the following three phrases: “increasing reactor,” “reactor pressure,” and “increasing reactor pressure.” In other words, the text section may be divided into overlapping phrases.

In some embodiments, parsing the incident report includes stemming a word by removing an ending. For example, the word “decided” may be stemmed to “decid*” in order to represent the words “decide,” “decided,” and “deciding,” among other things.

After parsing the incident report, operation 603 determines condition scores for each parsed individual word and parsed phrase. In some embodiments, less than all parsed words or phrases may be scored. For example, articles (i.e., “a, an, the”) may not be scored.

Each parsed word or phrase may receive an abnormal condition score which indicates a likelihood of an abnormal condition given the inclusion of the word or phrase in the incident report or in the specific text portion of the incident report. Where the incident report is evaluated according to a plurality of metrics, a parsed word or phrase may receive more than one score. For example, under the CAP metric, the word “unit” may receive a higher abnormal condition score than under the WR metric.

Each parsed word or phrase may receive a normal condition score which indicates a likelihood of a normal condition given the inclusion of the word or phrase in the incident report or in the specific text portion of the incident report. Where the industrial management report is evaluated according to a plurality of metrics, a parsed word or phrase may receive more than one score. For example, under the CAP metric, the word “unit” may receive a lower normal condition score than under the WR metric.

To determine a score for an individual word or phrase, operation 603 may analyze historical incident reports corresponding to both normal conditions and abnormal condition to determine the likelihood each word/phrase would appear in a report associated with a normal condition and each time the word/phrase would appear in a report associated with an abnormal condition.

In some embodiments, the score is determined in part based on the text portion where the word appears. Either condition score may be determined based on the likelihood a word/phrase would appear in the text portion given a normal condition/abnormal condition.

After scoring the parsed words and phrases of the incident report, process 600 proceeds to operation 605 where the incident report is selectively flagged for review based on the abnormal condition scores and the normal condition scores, among other things. Using the abnormal condition scores and the normal condition scores, a confidence value is determined for each text portion, the confidence value indicating a confidence in determining the incident report should be flagged for review. Additional confidence scores may be determined based on a combination of or analysis of other confidence scores, among other things.

After determining the confidence scores, each confidence score is compared to a threshold. The threshold for each score may be different based on an analysis of false positives and false negatives for each confidence score. If the confidence score exceeds the threshold, the confidence score indicates the report should be flagged for review. In some embodiments, if any confidence score exceeds its corresponding threshold, the report is flagged for review.

The IR user interface 200 may use the abnormal condition scores and the normal condition scores to determine the words or phrases in the incident report most indicative of a normal condition or an abnormal condition. In operation 607, the process 600 generates the ranking of the abnormal condition ranked list 251 and generates the ranking of the normal condition score ranked list 253. As illustrated in FIG. 4, the scores are ranked in descending order with the highest score indicating that the inclusion of the word in the incident report is most indicative of a normal or abnormal condition.

After generating the abnormal condition score ranked list 251 and the normal condition score ranked list 253, process 600 determines a subset of the ranked words/phrases to mark in operation 609. The subset corresponds to the highest value for each score. The subset may be a fixed percentage or number of the total number of scored words, among other things.

In some embodiments where a word or phrase appears in the subset for both normal condition scores and abnormal condition scores, the word or phrase may be marked according to which condition score is greater.

The process 600 proceeds to generating the incident report user interface 200 in operation 611. The IR user interface 200 includes the IR text section 230. The IR user interface may also include the flag section 210, the ranking section 250, the related IR section 260, and the referenced IR section 270, among other things.

The process 600 then marks words/phrases in the IR text section 230 with one or more visual indicators. As described above, one attribute of the marking may indicate a word or phrase is within one of the subsets, and another attribute of the marking may indicate the ranking of the word or phrase within the subset. For example, the subset of words based on the normal condition scores may be highlighted in one color and tinted to indicate the ranking. Likewise, the subset of words based on the abnormal condition scores may be highlighted in another color and tinted to indicate the ranking.

Where the words of the incident report were stemmed, the words or phrases of the incident report may be marked by tracking the word position, then adding the original ending of the word, among other things.

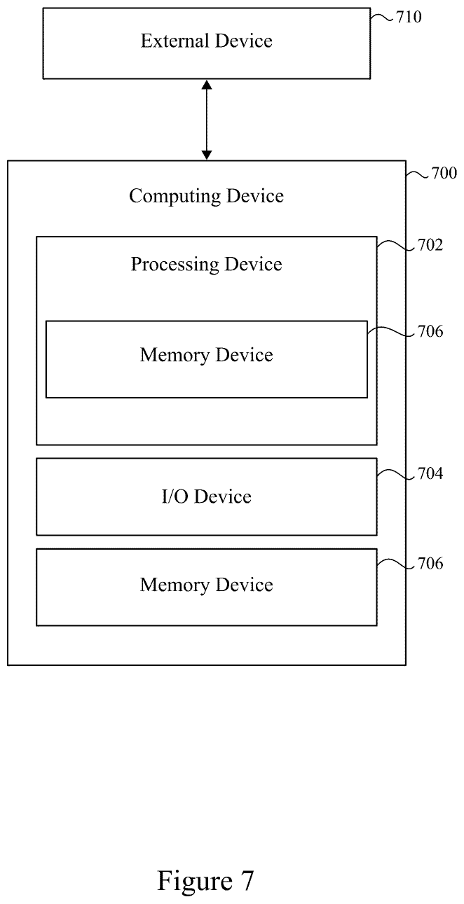

FIG. 7 schematically shows a computing device 700 in accordance with various embodiments. The computing device 700 is one example of a computing device which is used to perform one or more operations of the process 600 illustrated in FIG. 6. The computing device 700 includes a processing device 702, an input/output device 704, and a memory device 706. The computing device 700 may be a stand-alone device, an embedded system, or a plurality of devices configured to display the IR user interface 200 or the flag list user interface 100. Furthermore, the computing device 700 may communicate with one or more external devices 710.

The input/output device 704 enables the computing device 700 to communicate with an external device 710. For example, the input/output device 704 may be the screens 101 and 201, a network adapter, a network credential, an interface, or a port (e.g., a USB port, serial port, parallel port, an analog port, a digital port, VGA, DVI, HDMI, Fire Wire, CAT 5, Ethernet, fiber, or any other type of port or interface), among other things. The input/output device 704 may be comprised of hardware, software, or firmware. The input/output device 704 may have more than one of these adapters, credentials, interfaces, or ports, such as a first port for receiving data and a second port for transmitting data, among other things.

The external device 710 may be any type of device that allows data to be input or output from the computing device 700. For example, the external device 710 may be a meter, a control system, a sensor, a mobile device, a reader device, equipment, a handheld computer, a diagnostic tool, a controller, a computer, a server, a printer, a screen, a keyboard, a mouse, or a touch screen display, among other things. Furthermore, the external device 710 may be integrated into the computing device 700. More than one external device may be in communication with the computing device 700.

The processing device 702 may be a programmable type, a dedicated, hardwired state machine, or a combination thereof. The processing device 702 may further include multiple processors, Arithmetic-Logic Units (ALUs), Central Processing Units (CPUs), Digital Signal Processors (DSPs), or Field-programmable Gate Arrays (FPGA), among other things. For forms of the processing device 702 with multiple processing units, distributed, pipelined, or parallel processing may be used. The processing device 702 may be dedicated to performance of just the operations described herein or may be used in one or more additional applications. The processing device 702 may be of a programmable variety that executes processes and processes data in accordance with programming instructions (such as software or firmware) stored in the memory device 706. Alternatively or additionally, programming instructions are at least partially defined by hardwired logic or other hardware. The processing device 702 may be comprised of one or more components of any type suitable to process the signals received from the input/output device 704 or elsewhere, and provide desired output signals. Such components may include digital circuitry, analog circuitry, or a combination thereof.

The memory device 706 in different embodiments may be of one or more types, such as a solid-state variety, electromagnetic variety, optical variety, or a combination of these forms, to name but a few examples. Furthermore, the memory device 706 may be volatile, nonvolatile, transitory, non-transitory or a combination of these types, and some or all of the memory device 706 may be of a portable variety, such as a disk, tape, memory stick, or cartridge, to name but a few examples. In addition, the memory device 706 may store data which is manipulated by the processing device 702, such as data representative of signals received from or sent to the input/output device 704 in addition to or in lieu of storing programming instructions, among other things. As shown in FIG. 7, the memory device 706 may be included with the processing device 702 or coupled to the processing device 702, but need not be included with both.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of the present invention as defined by any of the appended claims. It shall nevertheless be understood that no limitation of the scope of the present disclosure is hereby created, and that the present disclosure includes and protects such alterations, modifications, and further applications of the exemplary embodiments as would occur to one skilled in the art with the benefit of the present disclosure.

What is claimed is:

1. A method for interpreting incident reports, comprising:
parsing an incident report;
determining a plurality of abnormal condition scores, each abnormal condition score corresponding to at least one parsed word of the incident report;
determining a plurality of normal condition scores, each normal condition score corresponding to at least one parsed word of the incident report;
generating a user interface including a visual representation of the incident report;
marking a set of parsed words corresponding to a portion of the plurality of abnormal condition scores using a first visual indicator; and
marking another set of parsed words corresponding to a portion of the plurality of normal condition scores using a second visual indicator.

2. The method of claim 1, wherein
parsing the incident report includes:
dividing the incident report into at least two portions;
dividing the first portion of the incident report into individual words; and
determining a plurality of phrases in the second portion of the incident report,
wherein the at least one parsed word corresponding to one of the abnormal condition scores is one of the individual words of the first portion or one of the phrases of the second portion.

3. The method of claim 2, wherein determining the plurality of phrases includes determining two-word phrases or three-word phrases.

4. The method of claim 1, comprising:
ranking the plurality of abnormal condition scores;
determining the portion of the plurality of abnormal condition scores after ranking the plurality of abnormal condition scores;
ranking the plurality of normal condition scores; and
determining the portion of the plurality of normal condition scores after ranking the plurality of abnormal condition scores.

5. The method of claim 4, wherein determining the portion of the plurality of normal condition scores includes comparing a first normal condition score and a first abnormal condition score corresponding to the same parsed word.

6. The method of claim 4, comprising:
marking the set of parsed words corresponding to the portion of the abnormal condition scores using a third visual indicator based on the ranking of the plurality of abnormal conditions scores; and
marking the set of parsed words corresponding to the portion of the normal condition scores using a fourth visual indicator based on the ranking of the plurality of normal condition scores.

7. The method of claim 6, wherein the first visual indicator includes highlighting in a first color, the second visual indicator includes highlighting in a second color, and the third and fourth visual indicators include degrees of highlighter tinting.

8. The method of claim 1, wherein parsing the incident report includes stemming a word of the incident report, and wherein marking the set of parsed words corresponding to the portion of the plurality of abnormal condition scores includes determining positions of the parsed words within the incident report.

9. The method of claim 1, comprising:
flagging the incident report in response to the plurality of abnormal condition scores and the plurality of normal condition scores.

10. The method of claim 1, wherein each of the plurality of abnormal condition scores indicate a likelihood of an abnormal condition given the inclusion of the corresponding at least one parsed word in a given portion of the incident report.

11. A computer program product for use on a computer system for interpreting incident reports, the computer program product comprising a tangible, non-transient computer usable medium having computer readable program code thereon, the computer readable program code comprising:
program code for parsing an incident report;
program code for determining a plurality of abnormal condition scores, each abnormal condition scores corresponding to at least one parsed word of the incident report;
program code for determining a plurality of normal condition scores, each normal condition score corresponding to at least one parsed word of the incident report;
program code for generating a user interface including a visual representation of the incident report;
program code for marking a set of parsed words corresponding to a portion of the plurality of abnormal condition scores using a first visual indicator; and
program code for marking another set of parsed words corresponding to a portion of the plurality of normal condition scores using a second visual indicator.

12. The computer program product of claim 11, wherein
parsing the incident report includes:
dividing the incident report into at least two portions;
dividing the first portion of the incident report into individual words; and
determining a plurality of phrases in the second portion of the incident report,
wherein the at least one parsed word corresponding to one of the abnormal condition scores is one of the individual words of the first portion or one of the phrases of the second portion.

13. The computer program product of claim 12, wherein determining the plurality of phrases includes determining two-word phrases or three-word phrases.

14. The computer program product of claim 11, comprising:
program code for ranking the plurality of abnormal condition scores;
program code for determining the portion of the plurality of abnormal condition scores using the plurality of abnormal condition scores ranking;
program code for ranking the plurality of normal condition scores; and
program code for determining the portion of the plurality of normal condition scores using the plurality of abnormal condition scores ranking.

15. The computer program product of claim 14, wherein determining the portion of the plurality of normal condition scores includes comparing a first normal condition score and a first abnormal condition score corresponding to the same parsed word.

16. The computer program product of claim 14, comprising:
program code for marking the set of parsed words corresponding to the portion of the abnormal condition scores using a third visual indicator based on the ranking of the plurality of abnormal conditions scores; and
program code for marking the set of parsed words corresponding to the portion of the normal condition scores using a fourth visual indicator based on the ranking of the plurality of normal condition scores.

17. The computer program product of claim 16, wherein the first visual indicator includes highlighting in a first color, the second visual indicator includes highlighting in a second color, and the third and fourth visual indicators include degrees of highlighter tinting.

18. The computer program product of claim 11, wherein parsing the incident report includes stemming a word of the incident report, and wherein marking the set of parsed words corresponding to the portion of the plurality of abnormal condition scores includes determining positions of the parsed words within the incident report.

19. The computer program product of claim 11, comprising:
flagging the incident report in response to the plurality of abnormal condition scores and the plurality of normal condition scores.

20. The computer program product of claim 11, wherein each of the plurality of abnormal condition scores indicate a likelihood of an abnormal condition given the inclusion of the corresponding at least one parsed word in a given portion of the incident report.
